(19) United States
(12) Patent Application Publication
(10) Pub. No.: US 2013/0291507 A1
(43) Pub. Date: Nov. 7, 2013

(54) Cotton Harvester Accessory and Harvesting Method

(71) Applicant: Douglas T. Williams, Winters, TX (US)

(72) Inventor: Douglas T. Williams, Winters, TX (US)

(21) Appl. No.: 13/875,015

(22) Filed: May 1, 2013

Related U.S. Application Data
(60) Provisional application No. 61/640,864, filed on May 1, 2012.

(51) Int. Cl. A01D 46/08

(52) U.S. Cl. CPC A01D 46/08
USPC 56/13.5; 29/426.2

(57) ABSTRACT

A conventional cotton harvester having a bale-forming accessory attached thereto and an improved cotton harvesting method are disclosed herein. The disclosed device generally comprises a conventional cotton harvester having its basket portion removed and having a bale-forming accessory attached to the cotton harvester in place of the removed basket portion.

### CROSS-REFERENCE TO RELATED APPLICATIONS

This application is related to and claims priority from earlier filed U.S. Provisional Patent Application No. 61/640,864, filed on May 1, 2012.

### BACKGROUND OF THE INVENTION

1. Field of the Invention

The present invention generally relates to agricultural equipment and accessories for harvesting crops. More specifically, the present invention relates to a cotton harvester with a bale-forming accessory and an improved harvesting method.

2. Description of Related Art

While cotton is a leading cash crop in the United States, cotton harvesting operations tend to be very laborious, time-consuming and expensive in terms of equipment costs and labor costs. Current methods of cotton harvesting typically utilize many expensive machines for transferring cotton from the field to the cotton gin. Cotton harvesters (i.e., cotton strippers and cotton pickers) use an air system to convey and elevate harvested cotton into a storage bin referred to as a basket. Once the basket is full, the cotton harvester must stop to dump the cotton into a boll buggy pulled by a tractor. Once the boll buggy is full, the boll buggy empties the cotton into the open top of a module builder which is rectangular in configuration and includes hydraulic rams for forming a large rectangular cotton module and ejecting the module after formation. The cotton module is then loaded into a specially built module truck for transport to the cotton gin.

Transferring harvested cotton among several different machines during the harvesting process is a key problem limiting productivity in the field and increasing operating costs. Considering the purchase cost of each machine used in the harvesting process, as well as maintenance and repair costs, fuel costs, insurance costs, and labor costs associated with each machine, one can understand the need for a new cotton harvester accessory and harvesting method that eliminates one or more of the machines and steps currently utilized in cotton harvesting operations.

In an attempt to decrease the number of harvesting machines and steps required for cotton harvesting operations, cotton harvesters recently have been developed that include an onboard module building system. Such devices, however, present several disadvantages that are overcome by the present invention.

While new cotton harvesters that have an onboard module building system offer the advantage of eliminating boll buggies, module builders and all the supporting equipment and labor traditionally needed during cotton harvest, at a price point far exceeding half a million dollars, such harvesters are cost-prohibitive for small to mid-size cotton producers. Additionally, despite the decreased equipment and labor costs, many cotton producers would be unable to recapture the high cost of such harvesters in the savings resulting from the decreased equipment and labor costs. Plus, many farmers are unwilling to take the risk of investing such a large sum of money in a relatively new technology. This is especially true for farmers who have already invested a large sum of money in a conventional cotton harvester, as poor resale values will further deter farmers from switching to new cotton harvesters. Finally, many farmers are hesitant to invest in these new harvesters due to the fear of being completely dependent on one piece of machinery to harvest cotton. If that one machine breaks down during the harvesting season, the farmer is left in a frustrating position of trying to repair an overly complex piece of machinery that the farmer is unfamiliar with, which can be very costly and time-consuming.

Currently, a need exists for an aftermarket cotton harvester accessory, having bale or module forming capabilities, that can be attached to a conventional cotton harvester. Unlike the current cotton harvesters that have an onboard module building system that are too costly for many cotton producers, a need exists for a device that is affordable and that can be used in conjunction with a cotton harvester already owned by the farmer. Furthermore, a method is needed for reconfiguring a conventional cotton harvester to include a bale-forming accessory in place of the basket portion included on conventional harvesters. Such a reconfigured cotton harvester is needed to eliminate boll buggies, module builders, and all of the supporting equipment and labor traditionally needed during cotton harvest. Furthermore, such a reconfigured cotton harvester is needed to decrease the operating costs associated with cotton harvesting operations by decreasing labor costs, equipment costs, maintenance costs, fuel costs, and insurance costs.

In view of the foregoing, it is apparent that a need exists in the art for a cotton harvester accessory and harvesting method which overcomes, mitigates or solves the above problems in the art. It is a purpose of this invention to fulfill this and other needs in the art which will become more apparent to the skilled artisan once given the following disclosure.

### OBJECTS AND SUMMARY OF THE INVENTION

It is an object of the present invention to overcome the above-described drawbacks associated with current devices. To achieve these and other advantages and in accordance with the purpose of the invention, as embodied and broadly described, the present disclosure describes a cotton harvester with a bale-forming accessory and an improved harvesting method.

The disclosed device generally comprises a conventional cotton harvester having its basket portion removed and having a bale-forming accessory attached to the cotton harvester in place of the removed basket portion. This device provides many advantages over current cotton harvesters. By utilizing a bale-forming accessory attached to a conventional cotton harvester, the disclosed device is affordable and is able to dramatically reduce the operating costs associated with cotton harvesting operations.

The disclosed device and harvesting method eliminate boll buggies, module builders, and all of the supporting equipment and labor traditionally needed during cotton harvest, which translates into labor and equipment savings for cotton producers. It is often challenging for cotton producers to find good and dependable laborers each year during harvesting season to operate multiple cotton harvesters, boll buggies and module builders. Using the disclosed device, a single operator can harvest more cotton using less equipment and in less time compared to current harvesting methods. The disclosed cotton harvester no longer wastes time waiting on a boll buggy to dump a full basket. Rather the disclosed device forms compact bales of cotton directly on the harvester. By eliminating the need for a module builder and a boll buggy, each pulled by a tractor, the disclosed device and harvesting method not only eliminate the labor required to operate that equipment, but also decrease fuel costs, insurance costs, and maintenance and repair costs associated with such harvesting equipment.

A cotton harvester with a bale-forming accessory constructed in accordance with the teachings of the present invention includes an air system directly feeding harvested cotton into the bale-forming accessory mounted on the harvester. In one embodiment, the harvested cotton is fed into a round-bale-forming accessory on the harvester to form a dense round bale or module. In another embodiment, the harvested cotton is fed into a square-bale-forming accessory on the harvester to form a dense square bale or module.

Another advantage of the disclosed device and harvesting method is that the compact bales produced by the disclosed device reduce cotton loss, increase transportability and facilitate expedited handling to the cotton gin. Conventional harvesting methods produce large cotton modules which must wait in the field to be carried to a cotton gin by a module truck. Since module trucks are relatively expensive and, thus, limited in number, cotton modules often remain in the field for extended periods of time before being transported to the cotton gin, which compromises the quality of the cotton. Cotton producers who generate round or square cotton bales from the disclosed reconfigured cotton harvester, however, have increased flexibility for getting such round or square bales to the gin, which reduces exposure of harvested cotton in the field. The compacted round or square bales are substantially easier to handle and load compared to large conventional modules and can be transported to the cotton gin on either a flatbed trailer or on a module truck.

A further advantage provided by the disclosed device and harvesting method is the decreased waste of harvested cotton. Since conventional harvesting methods include the transfer of cotton among several different machines, harvested cotton is often lost between transfers due to blowing wind or poor dumping technique. The disclosed device, however, produces compact bales onboard the device without ever transferring the harvested cotton to another machine and, thus, eliminates the loss of cotton due to blowing wind or poor dumping technique. Another advantage of the disclosed device is that it can operate in windy weather conditions, unlike conventional harvesters using conventional harvesting methods.

Another advantage is that the disclosed method for reconfiguring a cotton harvester does not permanently alter the harvester. If desired by the cotton producer, after the cotton harvester has been reconfigured to include a bale-forming accessory, the cotton harvester can always be reconfigured back to its original configuration by removing the bale-forming accessory and reattaching the basket portion for receiving harvested cotton. Whether for resale purposes or any other purpose desired by the cotton producer, the reconfigured cotton harvester may be changed back to its original configuration if so desired by the cotton producer.

These, together with other objects of the invention, along with various features of novelty that characterize the invention, are pointed out with particularity in the claims annexed hereto and forming a part of this disclosure. For a better understanding of the invention, its operating advantages, and the specific objects attained by its uses, reference should be had to the accompanying drawings and descriptive matter in which there is described illustrative embodiments of the invention.

### BRIEF DESCRIPTION OF THE DRAWINGS

The accompanying drawings, which are incorporated in and form a part of the specification, illustrate embodiments of the present invention, and together with the description, serve to explain the principles of the invention. It is to be expressly understood that the drawings are for the purpose of illustration and description only and are not intended as a definition of the limits of the invention. In the drawings:

FIG. 1 is a side view of a cotton harvester including a bale-forming accessory attached thereto in accordance with the teachings of the present disclosure.

FIG. 2 is a side view of FIG. 1 including removable side cover panels concealing said bale-forming accessory.

FIG. 3 is a side view of FIG. 1 showing the bale-forming accessory ejecting a bale of cotton.

FIG. 4 is a side view of FIG. 3 including removable side cover panels partially concealing said bale-forming accessory.

FIG. 5 is a side view of an alternative embodiment of a cotton harvester including a bale-forming accessory attached thereto in accordance with the teachings of the present disclosure.

### DETAILED DESCRIPTION OF ILLUSTRATIVE EMBODIMENTS

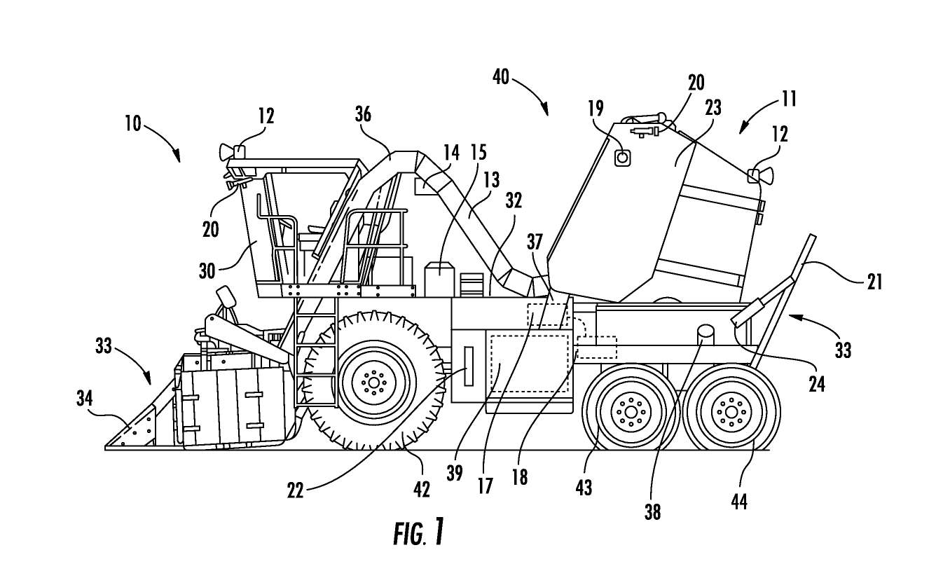

Referring now to FIGS. 1-5, exemplary embodiments of a cotton harvester 10 with a bale-forming accessory 11 attached thereto in accordance with the present disclosure are illustrated.

Turning to FIG. 1, a cotton harvester 10 with a bale-forming accessory 11 attached thereto is illustrated and generally includes a conventional cotton harvester 10 having a cotton conveying structure 36 and having its basket portion removed; a bale-forming accessory 11 attached to said cotton harvester 10 in place of said basket portion; a self-contained hydraulic unit (generally including 15, 17 and 18) for operating said bale-forming accessory 11; and ductwork 13 connecting said cotton conveying structure 36 to said bale-forming accessory 11.

The cotton harvester 40 according to the present disclosure includes a conventional cotton harvester 10, such as a cotton picker or a cotton stripper. A cotton harvester 10 already owned by a cotton producer may be used with the disclosed device 40. While FIGS. 1-5 illustrate the cotton harvester 10 as a conventional cotton picker, it should be understood that a cotton stripper also may be used, as both types of cotton harvesters 10 are considered to be within the spirit and scope of the present invention.

The cotton harvester 40 according to the present disclosure includes a main frame 32 supported for movement by a pair of forward wheels 42 and a pair of rear wheels 43. An operator cab 30 is supported at the forward end of the main frame 32 above a harvesting head assembly 33. The forwardly-extending harvesting head assembly 33 is mounted on the forward end of the cotton harvester 10 and includes a plurality of row harvesting units 34 for removing cotton from rows of cotton plants. Each row harvesting unit 34 delivers the harvested cotton though a cotton conveying structure 36. The cotton conveying structure 36 extends rearwardly and upwardly from the row harvesting units 34 to move the harvested cotton from the row units 34 to a structure mounted rearwardly of the cab 30.

On a conventional cotton harvester 10, the structure mounted to the main frame 32 rearwardly of the cab 30 is a basket portion (not illustrated) for receiving harvested cotton from the outlet opening of the cotton conveying structure 36. As shown in the attached figures, the basket portion has been removed from the main frame 32 of the disclosed device 40. The basket portion may be detached from the main frame 32 of the harvester 10 by unbolting the basket from its attachment points fixed to the main frame 32. The basket is unbolted from the main frame 32 in a manner that will be appreciated by those skilled in the art. Once the basket portion is removed, a bale-forming accessory 11 may be mounted to the main frame 32, as described in detail below. In order to support the additional weight of the bale-forming accessory 11 compared to the weight of the basket portion, an additional axle and pair of rear wheels 44 may be added to the disclosed harvester 40, as illustrated in the accompanying figures.

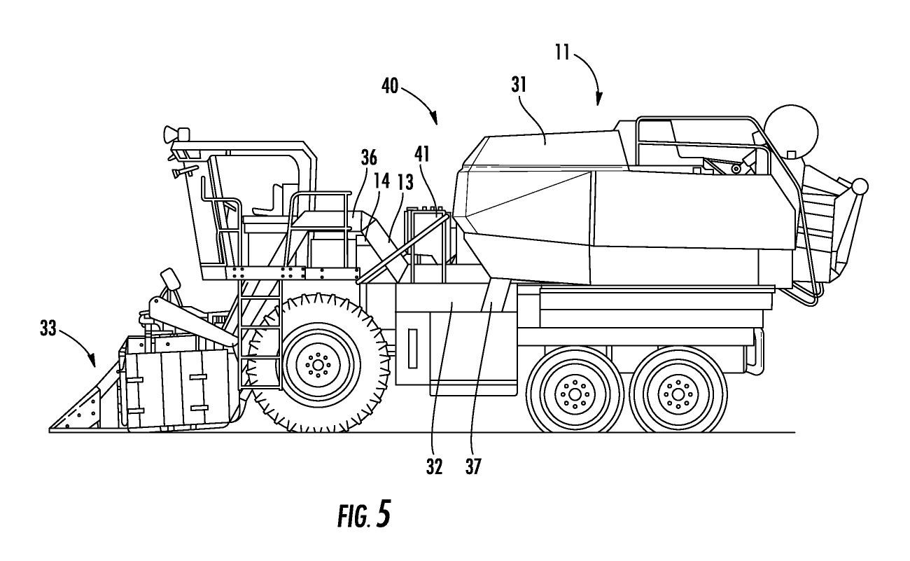

In the embodiments shown in the attached figures, the main frame 32 is configured to support a bale-forming accessory 11 behind the cab 30 in place of the removed basket portion. As shown in the embodiment illustrated in FIG. 5, the main frame 32 may have to be reconfigured to extend farther rearwardly than the main frame 32 of a conventional cotton harvester 10 in order to provide adequate support for the attached bale-forming accessory 11. In such a case, a platform may be fabricated and attached to the main frame 32 to support the bale-forming accessory 11.

The bale-forming accessory 11 is mounted to the main frame 32 of the cotton harvester 10 via one or more attachment members 37 and 38 fixed to the main frame 32. The attachment members 37 and 38 may define metal supports, beams, rods or the like. Those skilled in the art will recognize that many variations of attachment members may be utilized with the disclosed device 40, as the various embodiments of the present invention are not limited to the use of any particular attachment member.

The attachment members 37 and 38 are fixed to the main frame 32 in a manner that allows the bale-forming accessory 11 to be securely attached to the attachment members 37 and 38 on the main frame 32. For example, the attachment members 37 and 38 may be welded or bolted to the main frame 32.

In one embodiment contemplated by the present disclosure, at least four attachment members, two forwardly-mounted attachment members 37 and two rearwardly-mounted attachment members 38, are mounted to the main frame 32 for attaching the bale-forming accessory 11 to the cotton harvester 10. Other embodiments are contemplated wherein greater or lesser numbers of attachment members are utilized to attach the bale-forming accessory 11 to the main frame 32.

The bale-forming accessory 11 is preferably attached to the cotton harvester 10 in such a manner that the bale-forming accessory 11 can be detached from the cotton harvester 10 and the basket portion can be reattached to the harvester 10 if such a change is ever desired by the cotton producer. For example, the bale-forming accessory 11 maybe bolted to the attachment members 37 and 38 on the main frame 32, so that the bale-forming accessory 11 subsequently may be unbolted from the attachment members 37 and 38 and the basket may be reattached to the main frame 32. Those skilled in the art will recognize that many variations of attachment mechanisms may be utilized with the disclosed device 40, as the various embodiments of the present invention are not limited to the use of any particular attachment mechanism.

The bale-forming accessory 11 included in the disclosed device 40 is configured to receive harvested cotton and produce a compact bale as the row harvesting units 34 move forwardly over a field of cotton. In the embodiments shown in the accompanying figures, the bale-forming accessory 11 essentially comprises a conventional baler, used for hay, straw, silage or similar crop material, adapted as required for handling harvested cotton, which is of a different size and consistency than hay and the like.

Conventionally, agricultural balers comprise a wheeled frame that is towed by a tractor over a field of hay, straw, silage or similar crop material that previously has been cut, windrowed or swathed. A pick-up assembly having pick-up teeth or tines, which transversely spans the inlet opening of the baler, lifts the crop material off the field and feeds such crop material to a baling chamber in which the crop material is compacted into a round or square bale. Since the disclosed device 40 includes ductwork 13 and an air system 14 for directly feeding harvested cotton into the inlet opening of the bale-forming accessory 11, the pick-up assembly included with commercially available balers is removed from the disclosed bale-forming accessory 11. Additionally, the wheels included with commercially available balers preferably are removed from the disclosed bale-forming accessory 11 since the disclosed accessory 11 sits on top of the main frame 32 of the harvester 10, rather than moving directly over the ground. In one embodiment contemplated by the present disclosure, two rearwardly-mounted attachment members 38 attach to the bale-forming accessory 11 where wheels were originally mounted on the accessory 11.

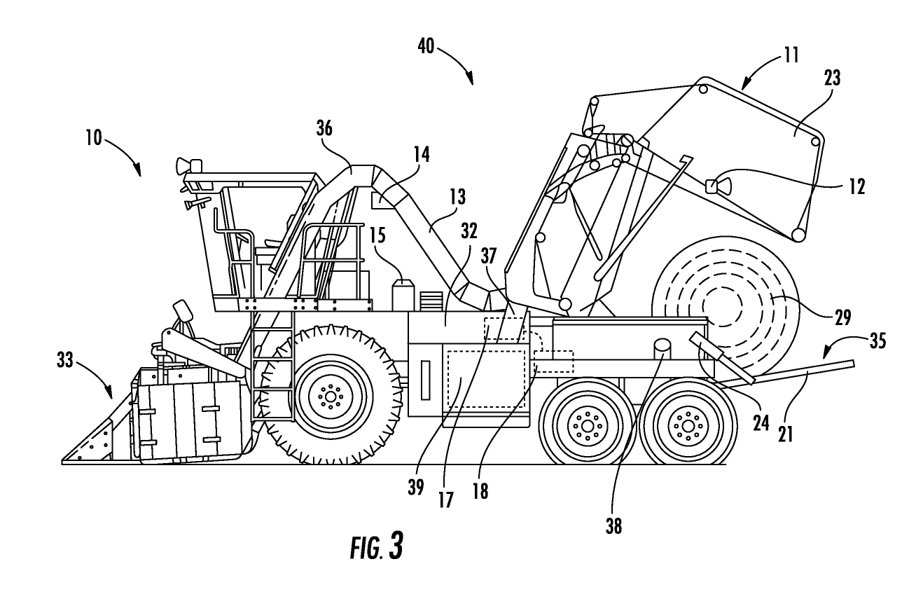

In the embodiments shown in FIGS. 1-4, the bale-forming accessory 11 is shown as including a round baler 23 generally of a conventional construction having a clamshell type of housing including a first section and a second section pivotally connected at a top portion, a baling chamber, a roller structure and round baler belts for forming a large round compact bale of cotton 29. As illustrated in FIG. 3, when a full-sized bale 29 is completed, discharge cylinders pivot the second section of the housing rearwardly and upwardly while the first section remains generally stationary, and the formed bale 29 is discharged rearwardly and downwardly onto a temporary bale carrying system 35 at the rear of the main frame 32 for intermediate storage and transport so harvesting can continue. The temporary bale carrying system 35 includes a carrier gate 21 and a hydraulic arm lift 24 for raising and lowering the carrier gate 21 as desired. The temporary bale carrying system 35 temporarily supports the bale 29 for transport during field-working operations and then, when the desired location (e.g., the end of the field) is reached, the hydraulic arm lift 24 is activated to lower the carrier gate 21 and release the bale 29 from the harvester 40.

In the embodiment shown in FIG. 5, the bale-forming accessory 11 is shown as including a square baler 31 generally of a conventional construction having a rectangular-shaped baling chamber into which harvested cotton is fed and compressed into a rectangular or “square” bale under the action of a reciprocating plunger. When each bale has reached a predetermined length, a tying mechanism is operated to encircle the bale with a plurality of strands so as to form a finished bale, which is subsequently ejected from the baler. It is to be understood that either a round-bale-forming accessory 23 or a square-bale-forming accessory 31 may be utilized with the disclosed invention as both accessories are considered to be within the spirit and scope of the present invention.

The compact cotton bales produced by the disclosed device 40 and harvesting method are easier to transport and facilitate expedited handling to the cotton gin, compared to conventional cotton modules. The round or square cotton bales can be lined up like large cotton modules and can be easily picked up and transported to the cotton gin by module trucks or flatbed trailers. Then, the cotton bales can be unloaded at the gin in the same manner as a conventional module.

The disclosed cotton harvester 40 is further reconfigured to lower the highest point of the device 40 when the bale-forming accessory 11 is attached thereto in order to facilitate improved transport of the device 40. The fuel tank of the cotton harvester 10 is typically located at the rear of the main frame 32 between the rear tires 43. In order to lower the height of the bale-forming accessory 11 on the disclosed harvester 40, the fuel tank is relocated to an area, generally indicated at 39, between the front wheels 42 and the rear wheels 43. By relocating the fuel tank 39 so that it is not positioned beneath the bale-forming accessory 11, the disclosed harvester 40 is able to provide a lower mounting position of the bale-forming accessory 11 on the main frame 32. This lowers the highest point of the disclosed harvester 40, measured from the ground to the top of the bale-forming accessory 11, by approximately two feet. Such a reconfiguration substantially reduces the transport height of the disclosed harvester 40 without affecting bale capacity of the bale-forming accessory 11.

In order to provide additional safeguards in the event of a fire, in addition to adding a fire extinguisher 22 to the disclosed harvester 40, a water tank, sized approximately the same size as the fuel tank, is mounted to the opposite side of the harvester 40 from the side on which the fuel tank is mounted (i.e., the area generally indicated at 39 on the opposite side of the harvester). The water tank includes a hose and a nozzle connected thereto to allow the operator to extinguish a fire in the case of such an incident. The harvester engine (not illustrated) is located between the fuel tank and the water tank on the disclosed harvester 40.

As an optional feature of the invention, a video monitor and camera system 20 may be included to allow the operator to monitor the bale-forming accessory 11 during harvest. Furthermore, smoke detectors 19 may be included on the bale-forming accessory 11 along with an alert system (e.g., a blinking light or siren device) installed inside the cab 30 to alert the operator of smoke or a fire. Since the bale-forming accessory 11 has solid walls that conceal the interior bale 29, such a smoke detector system 19 and camera system 20 provide additional safeguards against fires, which pose great danger during the harvesting process.

An additional feature shown in the illustrated embodiments is extra lighting 12 added to the cab 30 of the disclosed harvester 40 and added to the bale-forming accessory 11. This allows the operator to see better in dark conditions and to work later into the night and earlier in the morning.

The disclosed harvester 40 further includes a self-contained hydraulic unit for operating the bale-forming accessory 11. Conventional agricultural balers have no power source of their own. Typically, a drive shaft of the baler is connected to a conventional power take-off or PTO shaft of a tractor to supply power from the tractor to the baler.

In the disclosed system, the hitch and the drive shaft, for connecting a commercially available baler to a tractor, are removed from the disclosed bale-forming accessory 11 and the bale-forming accessory 11 is powered by a self-contained hydraulic unit. The hydraulic unit includes hydraulic hoses connecting a hydraulic fluid tank 15 to a hydraulic pump 18, a power source connected to the hydraulic pump 18 to turn the hydraulic pump 18, and hydraulic hoses connecting the hydraulic pump 18 to a hydraulic motor 17. The hydraulic pump 18 may be driven by a coupler connected to the engine of the harvester 10. The hydraulic motor 17 is connected to a gear box of the bale-forming accessory 11 for operating the bale-forming accessory 11. Alternatively, as illustrated in the embodiment shown in FIG. 5, the bale-forming accessory 11 may be powered by an engine 41.

The disclosed cotton harvester 40 further includes ductwork 13 for connecting the outlet opening of the cotton conveying structure 36 to the inlet opening of the bale-forming accessory 11. The cotton conveying structure 36 is configured to receive harvested cotton from the row harvesting units 34 and to convey the harvested cotton to the attached ductwork 13. The ductwork 13 forms a passageway for the transfer of harvested cotton from the cotton conveying structure 36 to the bale-forming accessory 11. The ductwork 13 may be made of sheet metal or any other suitable materials.

In one of the embodiments contemplated by the current disclosure, the ductwork 13 includes a passageway having two open ends. A first end of the ductwork 13 connects to the outlet opening of the cotton conveying structure 36 and a second end of the ductwork 13 connects to the inlet opening of the bale-forming accessory 11. The ductwork 13 may further include one or more air systems 14, such as hydraulically driven air fans, for improving cotton delivery to the inlet opening of the bale-forming accessory 11. Air from a source (not illustrated) on the harvesting head assembly 33 is directed upwardly into the cotton conveying structure 36 to move harvested cotton from the row units 34 and propel it upwardly. Air from a source, indicated generally at 14, attached to the ductwork 13 is directed downwardly into the ductwork 13 to move the harvested cotton from the cotton conveying structure 36 and propel it downwardly and rearwardly into the inlet opening of the bale-forming accessory 11.

In alternative embodiments, the air source forcing the cotton through the cotton conveying structure 36, in conjunction with the configuration of the ductwork and the downward pull of gravity, may be sufficient for conveying the harvested cotton through the ductwork 13 and into the inlet opening of the bale-forming accessory 11.

As previously mentioned, the embodiments illustrated in the attached figures depict the cotton harvester 10 as a cotton picker. The main difference, for the purposes of the disclosed invention, between a cotton picker and a cotton stripper is the addition of a burr extractor machine (not illustrated) located directly behind the cab 30 of a cotton stripper. On a cotton stripper, the cotton conveying structure 36 is connected to and feeds cotton into an inlet opening of the burr extractor. The ductwork 13 of the disclosed device 40 would therefore be connected to an outlet opening of the burr extractor, rather than directly to the cotton conveying structure 36, on a cotton stripper.

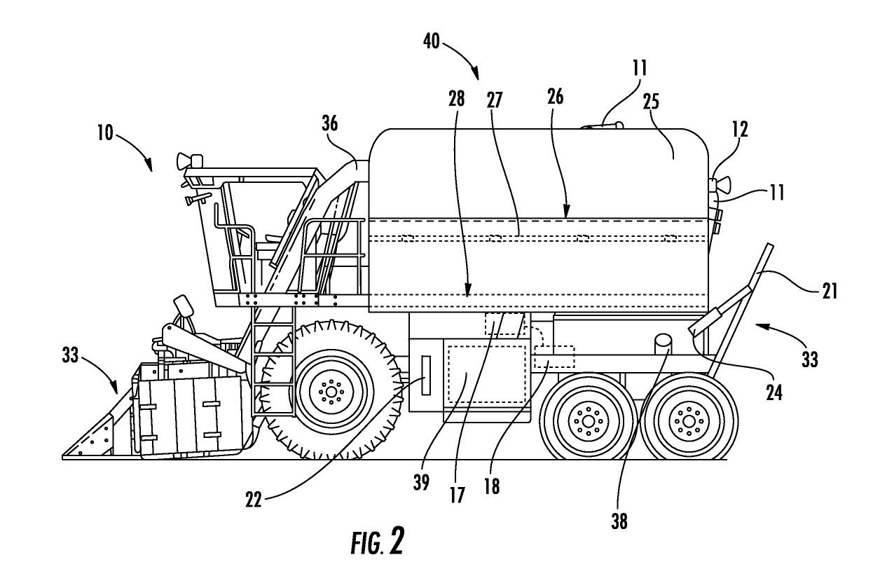

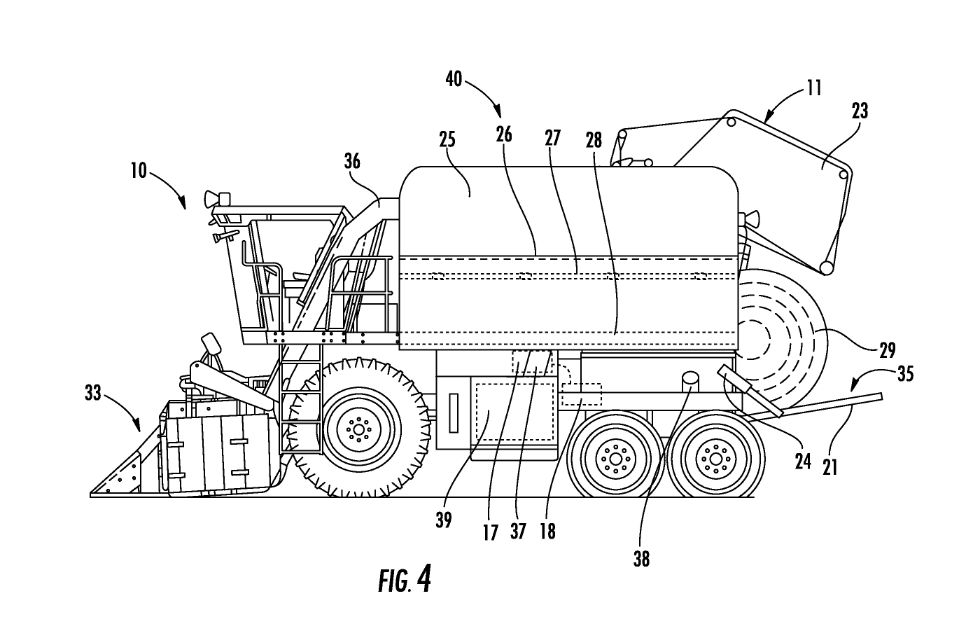

In the embodiments shown in FIGS. 2 and 4, the disclosed device 40 further includes side cover panels 25 to neatly conceal the bale-forming accessory 11 and the ductwork 13 of the disclosed harvester 40. Preferably, the cover panels 25 are attached to the main frame 32 on both sides of the cotton harvester 40. The cover panels 25 may be attached to the main frame 32 using attachment mechanisms known in the art.

The side cover panels 25 further include an interior catwalk 28 that runs even with the catwalk formed around the cab 30. The cover panel catwalk 28 extends horizontally from the main frame 32 to provide room for the operator to walk around the bale-forming accessory 11 and work on any problems occurring with parts mounted to the main frame 32. This provides increased safety for the cotton producer to repair or work on malfunctioning parts. The cover panels 25 further include a hinge 26 approximately halfway down the center of the panels 25 which allows the cover panels 25 to be folded down when desired, such as when the concealed parts are being worked on. The cover panels 25 further include an interior handrail 27 to provide increased safety when walking around the catwalk 28.

It is important to note that the construction and arrangement of the elements of the device provided herein are illustrative only. Although only a few exemplary embodiments of the present invention have been described in detail in this disclosure, those skilled in the art who review this disclosure will readily appreciate that many modifications are possible in these embodiments (such as variations in orientation of the components of the system, sizes, structures, shapes and proportions of the various components, etc.) without materially departing from the novel teachings and advantages of the invention.

Many other uses of the present invention will become obvious to one skilled in the art upon acquiring a thorough understanding of the present invention. Once given the above disclosures, many other features, modifications and variations will become apparent to the skilled artisan in view of the teachings set forth herein. Such other uses, features, modifications and variations are, therefore, considered to be a part of this invention, the scope of which is to be determined by the following claims.

The invention claimed is:

1. A cotton harvester with a bale-forming accessory attached thereto, comprising:
a conventional cotton harvester having its basket portion removed, including:
a main frame supported for movement by a pair of forward wheels and a pair of rear wheels,
an operator cab supported at the forward end of the main frame,
a harvesting head assembly including a plurality of row harvesting units and mounted on the forward end of the main frame below said operator cab, and
a cotton conveying structure extending rearwardly and upwardly from said row harvesting units;
a bale-forming accessory, including:
a conventional baler having an inlet opening for receiving harvested cotton into a baling chamber, and having the following parts removed: wheels for movement over a ground surface, a pick-up assembly transversely spanning the inlet opening of the baler, a hitch, and a drive shaft,
wherein said bale-forming accessory is attached to said main frame in place of said removed basket portion by attaching said bale-forming accessory to one or more attachment members mounted on said main frame;
a self-contained hydraulic unit for operating said bale-forming accessory, including:
a hydraulic fluid tank,
a hydraulic pump connected to said hydraulic fluid tank,
a power source connected to said hydraulic pump for turning said pump, and
a hydraulic motor connected to said hydraulic pump,
wherein said hydraulic motor is connected to a gear box of said bale-forming accessory for operating said bale-forming accessory; and
ductwork including two open ends, wherein a first end is connected to an outlet opening of said cotton conveying structure and a second end is connected to said inlet opening of said bale-forming accessory.

2. The cotton harvester according to claim 1, wherein said main frame is supported by an additional rear axle having an additional pair of rear wheels attached thereto.

3. The cotton harvester according to claim 1, wherein a fabricated platform is attached to said main frame to support said bale-forming accessory.

4. The cotton harvester according to claim 1, wherein said attachment members include metal supports, beams, or rods.

5. The cotton harvester according to claim 1, wherein said power source is an engine of said harvester.

6. The cotton harvester according to claim 1, wherein said bale-forming accessory is releasably fastened to said attachment members in a manner that allows said bale-forming accessory subsequently to be unfastened from said attachment members.

7. The cotton harvester according to claim 1, wherein said ductwork further includes an air system for directing harvested cotton into said inlet opening of the bale-forming accessory.

8. The cotton harvester according to claim 7, wherein said air system includes one or more hydraulically driven air fans.

9. The cotton harvester according to claim 1, wherein said baler is a round baler comprising a clamshell type of housing including a first section and a second section pivotally connected at a top portion, a roller structure and baler belts for forming a round bale of cotton.

10. The cotton harvester according to claim 1, wherein said cotton harvester further includes a temporary bale carrying system attached to the rear of the main frame, wherein said temporary bale carrying system includes a carrier gate and a hydraulic arm lift connected to said carrier gate for raising and lowering said gate.

11. The cotton harvester according to claim 10, wherein said cotton harvester is used for a method of harvesting cotton, said method comprising the following steps:
moving said row harvesting units of the cotton harvester forwardly over rows of cotton plants;
conveying cotton from said row harvesting units through said cotton conveying structure utilizing an air system located in said harvesting head assembly;
conveying cotton from said cotton conveying structure through said ductwork and through said inlet opening of said bale-forming accessory;
compacting cotton into a bale in said baling chamber of said b ale-forming accessory;
ejecting said cotton bale from said baling chamber onto said temporary bale carrying system;
continue harvesting until a desired location of the field is reached by the cotton harvester; and
activating said hydraulic arm lift to lower said carrier gate for releasing said bale from the harvester at the desired location of the field.

12. A method for decreasing the transport height of the cotton harvester according to claim 1, said method comprising the following steps:
relocating a fuel tank for fueling said harvester, which is originally positioned towards the rear of said main frame and beneath said bale-forming accessory, to an area between one of said forward wheels and one of said rear wheels; and
lowering the mounting position of said bale-forming accessory on said main frame.

13. The cotton harvester according to claim 1, wherein said cotton harvester further includes a water tank positioned between one of said forward wheels and one of said rear wheels, wherein said water tank includes a hose and a nozzle connected to said hose for emitting water from said water tank.

14. The cotton harvester according to claim 1, wherein said cotton harvester further includes side cover panels for concealing said bale-forming accessory and said ductwork of said cotton harvester.

15. The cotton harvester according to claim 14, wherein said cover panels further include an interior catwalk, a hinge allowing the cover panels to be folded down so that the bale-forming accessory and ductwork are only partially concealed, and an interior handrail.

16. The cotton harvester according to claim 1, wherein said cotton harvester further includes a video monitor and camera system including one or more cameras mounted to the bale-forming accessory, wherein the camera system relays video images to a video monitor located inside said cab.

17. The cotton harvester according to claim 1, wherein said cotton harvester further includes smoke detectors on said bale-forming accessory, wherein said smoke detectors are linked to an alert system installed inside said operator cab to alert the operator of smoke or a fire.

18. A cotton harvester with a bale-forming accessory attached thereto, comprising:
a conventional cotton harvester having its basket portion removed, including:
a main frame supported for movement by forward wheels and rear wheels,
an operator cab supported at the forward end of the main frame,
a harvesting head assembly including a plurality of row harvesting units and mounted on the forward end of the main frame below said operator cab, and
a cotton conveying structure extending rearwardly and upwardly from said row harvesting units;
a bale-forming accessory, including:
a conventional baler having an inlet opening for receiving harvested cotton into a baling chamber, and having the following parts removed: wheels for movement over a ground surface, a pick-up assembly transversely spanning the inlet opening of the baler, a hitch, and a drive shaft,
wherein said bale-forming accessory is attached to said main frame in place of said removed basket portion by attaching said bale-forming accessory to one or more attachment members mounted on said main frame;
an engine for operating said bale-forming accessory; and
ductwork including two open ends, wherein a first end is connected to an outlet opening of said cotton conveying structure and a second end is connected to said inlet opening of said bale-forming accessory.

19. The cotton harvester according to claim 18, wherein said baler is a square baler comprising a rectangular-shaped baling chamber into which harvested cotton is fed and compressed into a rectangular bale under the action of a reciprocating plunger.

20. A cotton harvester with a bale-forming accessory attached thereto, comprising:
a conventional cotton harvester having its basket portion removed, including:
a main frame supported for movement by forward wheels and rear wheels,
an operator cab supported at the forward end of the main frame,
a harvesting head assembly including a plurality of row harvesting units and mounted on the forward end of the main frame below said operator cab,
a burr extractor machine attached to said main frame and positioned behind said cab and including an inlet opening and an outlet opening, and
a cotton conveying structure extending rearwardly and upwardly from said row harvesting units and including an outlet opening connected to said inlet opening of said burr extractor machine;
a bale-forming accessory, including:
a conventional baler having an inlet opening for receiving harvested cotton into a baling chamber, and having the following parts removed:
wheels for movement over a ground surface, a pick-up assembly transversely spanning the inlet opening of the baler, a hitch, and a drive shaft,
wherein said bale-forming accessory is attached to said main frame in place of said removed basket portion by attaching said bale-forming accessory to one or more attachment members mounted on said main frame;
a self-contained hydraulic unit for operating said bale-forming accessory, including:
a hydraulic fluid tank,
a hydraulic pump connected to said hydraulic fluid tank,
a power source connected to said hydraulic pump for turning said hydraulic pump, and
a hydraulic motor connected to said hydraulic pump,
wherein said hydraulic motor is connected to a gear box of said bale-forming accessory for operating said bale-forming accessory; and
ductwork including two open ends, wherein a first end is connected to said outlet opening of said burr extractor machine and a second end is connected to said inlet opening of said bale-forming accessory.

21. A method for reconfiguring a conventional cotton harvester to include a bale-forming accessory, said method comprising the following steps:
removing a basket portion from a main frame of said conventional cotton harvester,
wherein said cotton harvester includes:
said main frame supported for movement by forward wheels and rear wheels,
an operator cab supported at the forward end of the main frame,
a harvesting head assembly including a plurality of row harvesting units and mounted on the forward end of the main frame below said operator cab, and
a cotton conveying structure extending rearwardly and upwardly from said row harvesting units;
obtaining a bale-forming accessory including:
a conventional baler having an inlet opening for receiving harvested cotton into a baling chamber;
removing the following parts from said baler:
wheels for movement over a ground surface,
a pick-up assembly transversely spanning the inlet opening of the baler,
a hitch, and
a drive shaft;
attaching said bale-forming accessory in place of said removed basket portion by attaching said bale-forming accessory to one or more attachment members mounted on said main frame;
adding a self-contained hydraulic unit to said harvester for operating said bale-forming accessory, said hydraulic unit including:
a hydraulic fluid tank,
a hydraulic pump connected to said hydraulic fluid tank,
a power source connected to said hydraulic pump for turning said hydraulic pump, and
a hydraulic motor connected to said hydraulic pump,
wherein said hydraulic motor is connected to a gear box of said bale-forming accessory for operating said bale-forming accessory; and
adding ductwork to said harvester, said ductwork including two open ends, wherein a first end is connected to an outlet opening of said cotton conveying structure and a second end is connected to said inlet opening of said bale-forming accessory.
